(19) United States
(12) Patent Application Publication
(10) Pub. No.: US 2009/0107519 A1
(43) Pub. Date: Apr. 30, 2009

(54) METHOD AND SYSTEM FOR CHEMICALLY ENHANCED LASER TRIMMING OF SUBSTRATE EDGES

(75) Inventors: Tetsuya Ishikawa, Saratoga, CA (US); Tsuyoshi Mitsuhashi, Shiga (JP); Ming Xi, Shanghai (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SOKUDO CO., LTD., Kyoto (JP)

(21) Appl. No.: 11/929,186

(22) Filed: Oct. 30, 2007

(51) Int. Cl. B08B 7/04

(52) U.S. Cl. 134/1.3; 134/1; 134/157

(57) ABSTRACT

An apparatus for processing a peripheral portion of a substrate includes a housing and a spin chuck mounted within the housing and configured to support the substrate in a substantially horizontal orientation. The apparatus also includes a fluid dispense nozzle coupled to the housing and proximate to the peripheral portion of the substrate. The fluid dispense nozzle is in fluid communication with a source of a chemical and configured to direct a flow of the chemical to the peripheral portion of the substrate located at a first radial distance from a center of the substrate. The apparatus further includes a light guide optically coupled to a laser source. The light guide is configured to direct radiation to the peripheral portion of the substrate located at a second radial distance from the center of the substrate greater than the first radial distance.

### BACKGROUND OF THE INVENTION

The present invention relates generally to the field of substrate processing equipment. More particularly, the present invention relates to a method and apparatus for removing films on a substrate. In a particular embodiment, the method and system are applied to create a predetermined edge stack profile for layers present on a semiconductor wafer. However, embodiments of the present invention are also applicable to other substrate processing procedures, including substrate cleaning, resist trimming, and the like.

Modern integrated circuits contain millions of individual elements that are formed by patterning the materials, such as silicon, metal and/or dielectric layers, that make up the integrated circuit to sizes that are small fractions of a micrometer. The technique used throughout the industry for forming such patterns is photolithography. A typical photolithography process sequence generally includes depositing one or more uniform photoresist (resist) layers on the surface of a substrate, drying and curing the deposited layers, patterning the substrate by exposing the photoresist layer to electromagnetic radiation that is suitable for modifying the exposed layer and then developing the patterned photoresist layer.

It is common in the semiconductor industry for many of the steps associated with the photolithography process to be performed in a multi-chamber processing system (e.g., a cluster tool) that has the capability to sequentially process semiconductor wafers in a controlled manner. One example of a cluster tool that is used to deposit (i.e., coat) and develop a photoresist material is commonly referred to as a track lithography tool.

Track lithography tools typically include a mainframe that houses multiple chambers (which are sometimes referred to herein as stations) dedicated to performing the various tasks associated with pre- and post-lithography processing. There are typically both wet and dry processing chambers within track lithography tools. Wet chambers include coat and/or develop bowls, while dry chambers include thermal control units that house bake and/or chill plates. Track lithography tools also frequently include one or more pod/cassette mounting devices, such as an industry standard FOUP (front opening unified pod), to receive substrates from and return substrates to the clean room, multiple substrate transfer robots to transfer substrates between the various chambers/stations of the track tool and an interface that allows the tool to be operatively coupled to a lithography exposure tool in order to transfer substrates into the exposure tool and receive substrates from the exposure tool after the substrates are processed within the exposure tool.

Over the years there has been a strong push within the semiconductor industry to shrink the size of semiconductor devices. The reduced feature sizes have caused the industry to move to higher resolution photolithography techniques. Such techniques are achieved in various way, but commonly achieved by placing scanning light sources as close as possible to the coated surface of substrates to expose the desired pattern into the photoresist. In some applications, such as immersion exposure, the output of light source is immersed in an index matched or optimized liquid on the surface of the substrate and scanned in a plane extremely close to and substantially parallel to the surface of the substrate so as to expose the highest resolution pattern possible. Due to the close proximity required for such close scanning techniques, it is important that the surface of the photoresist coated substrates are as planar as possible.

Additionally, increasing the useable surface area is desirable to increase device yield per wafer. Many of the layers deposited during photolithography processes, such as the bottom anti-reflective coating (BARC), photoresist, and top coat layers, are deposited on the surface of the substrate using a conventional spin-on fluid dispense process. During dispense processes, it is possible for the lateral extent of the various layers to be non-uniform, creating a non-uniform edge stack profile at the outer edge of the substrate. A non-uniform edge stack profile generally results in a reduction in the wafer area available for active devices, thereby decreasing the device yield per wafer. Thus, there is a need in the art for improved methods and systems for processing resist and other layers present at the substrate edge.

### SUMMARY OF THE INVENTION

According to an embodiment of the present invention, an apparatus for processing a peripheral portion of a substrate is provided. The apparatus includes a housing and a spin chuck mounted within the housing and configured to support the substrate in a substantially horizontal orientation. The apparatus also includes a fluid dispense nozzle coupled to the housing and proximate to the peripheral portion of the substrate. The fluid dispense nozzle is in fluid communication with a source of a chemical and configured to direct a flow of the chemical to the peripheral portion of the substrate located at a first radial distance from a center of the substrate. The apparatus further includes a light guide optically coupled to a laser source. The light guide is configured to direct radiation to the peripheral portion of the substrate located at a second radial distance from the center of the substrate greater than the first radial distance.

According to another embodiment of the present invention, a method of processing material present on a peripheral portion of a topside of a substrate is provided. The method includes placing the substrate on a spin chuck and chucking the substrate to the spin chuck. The method also includes rotating the substrate about an axis of the spin chuck and flowing a chemical onto the peripheral portion of the topside of the substrate. The chemical flows along a radial direction across the topside of the substrate. The method further includes exposing at least a portion of the peripheral portion of the topside of the substrate to incident radiation. The incident radiation enhances a chemical reaction between the chemical and the material. Additionally, the method includes removing at least a portion of the material present on the peripheral portion of the topside of the substrate.

According to an alternative embodiment of the present invention, a system for trimming an edge of a semiconductor wafer is provided. The system includes a treatment chamber configured to receive and support the semiconductor wafer and a fluid dispense system coupled to the treatment chamber and configured to provide a chemical flow into the treatment chamber. The systems also includes a fluid dispense nozzle in fluid communication with the fluid dispense system and disposed in the treatment chamber. The fluid dispense nozzle is positioned proximate to a peripheral portion of the semiconductor wafer and configured to direct a flow of a chemical from the fluid dispense system to the peripheral portion of the semiconductor wafer at a first radial distance. The system further includes a laser system in optical communication with the treatment chamber, one or more optical elements configured to direct radiation from the laser system to impinge on the peripheral portion of the semiconductor wafer at a second radial distance greater than the first radial distance, and a controller coupled to the treatment chamber, the fluid dispense system, and the laser system.

Many benefits are achieved by way of the present invention over conventional techniques. For example, embodiments of the present invention provide for increases in usable wafer area, which provide for increased device yields. Additionally, embodiments reduce the amount of material contributing to the generation of particles, which adversely impact device yield and reliability. Depending upon the embodiment, one or more of these benefits, as well as other benefits, may be achieved. These and other benefits will be described in more detail throughout the present specification and more particularly below in conjunction with the following drawings.

### BRIEF DESCRIPTION OF THE DRAWINGS

FIG. 1 is a simplified architecture of a track lithography tool according to an embodiment of the present invention;

FIG. 2 is a simplified schematic diagram illustrating an edge exposure unit according to an embodiment of the present invention;

FIG. 3 is a simplified flowchart illustrating a method of performing edge trimming according to an embodiment of the present invention; and

FIG. 4 is a simplified schematic diagram illustrating a wafer edge trimming system according to an embodiment of the present invention.

### DETAILED DESCRIPTION OF SPECIFIC EMBODIMENTS

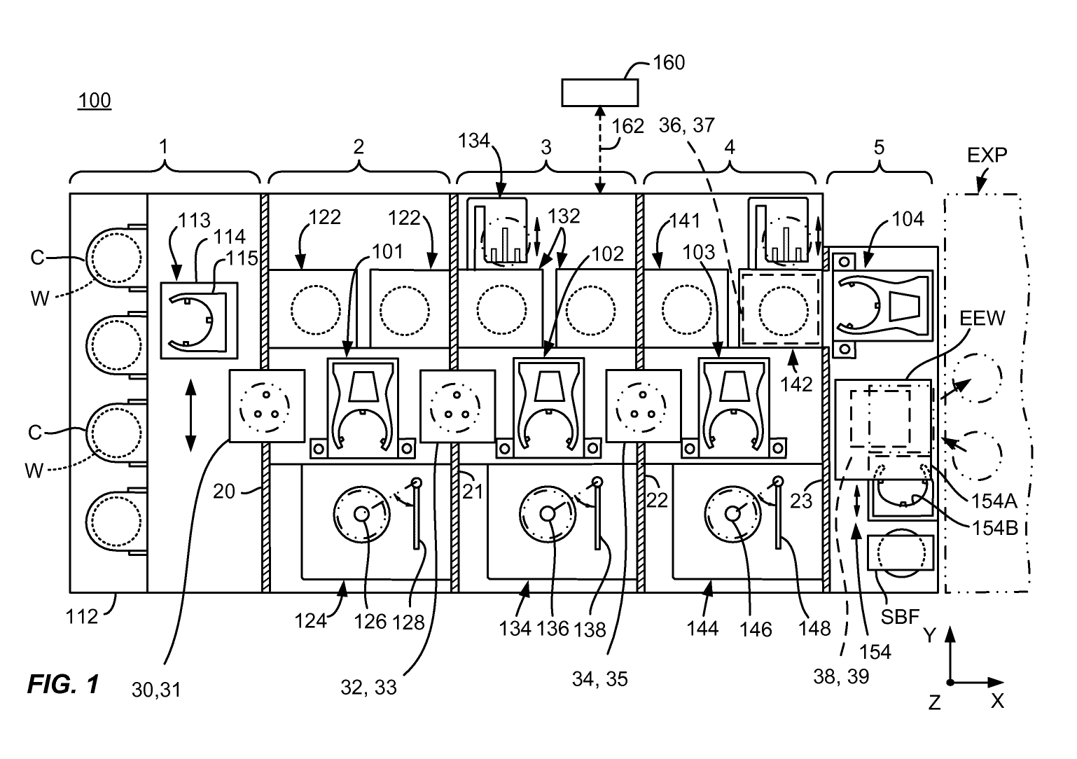

FIG. 1 is a plan view of a track lithography tool according to an embodiment of the present invention. In the embodiment illustrated in FIG. 1, the track lithography tool is coupled to an immersion scanner. An XYZ rectangular coordinate system in which an XY plane is defined as the horizontal plane and a Z axis is defined to extend in the vertical direction is additionally shown in FIG. 1 for purposes of clarifying the directional relationship therebetween.

In a particular embodiment, the track lithography tool is used to form, through use of a coating process, an anti-reflection (AR) and a photoresist film on substrates, for example, semiconductor wafers. The track lithography tool is also used to perform a development process on the substrates after they have been subjected to a pattern exposure process. The substrates processed by the track lithography tool are not limited to semiconductor wafers, but may include glass substrates for a liquid crystal display device, and the like.

The track lithography tool 100 illustrated in FIG. 1 includes an factory interface block 1, a BARC (Bottom Anti-Reflection Coating) block 2, a resist coating block 3, a development processing block 4, and a scanner interface block 5. In the track lithography tool, the five processing blocks 1 to 5 are arranged in a side-by-side relation. An exposure unit (or stepper) EXP, which is an external apparatus separate from the track lithography tool is provided and coupled to the scanner interface block 5. Additionally, the track lithography tool and the exposure unit EXP are connected via LAN lines 162 to a host computer 160.

The factory interface block 1 is a processing block for transferring unprocessed substrates received from outside of the track lithography tool to the BARC block 2 and the resist coating block 3. The factory interface block 1 is also useful for transporting processed substrates received from the development processing block 4 to the outside of the track lithography tool. The factory interface block 1 includes a table 112 configured to receive a number of (in the illustrated embodiment, four) cassettes (or carriers) C, and a substrate transfer mechanism 113 for retrieving an unprocessed substrate W from each of the cassettes C and for storing a processed substrate W in each of the cassettes C. The substrate transfer mechanism 113 includes a movable base 114, which is movable in the Y direction (horizontally) along the table 112, and a robot arm 115 mounted on the movable base 114.

The robot arm 115 is configured to support a substrate W in a horizontal position during wafer transfer operations. Additionally, the robot arm 115 is capable of moving in the Z direction (vertically) in relation to the movable base 114, pivoting within a horizontal plane, and translating back and forth in the direction of the pivot radius. Thus, using the substrate transfer mechanism 113, the holding arm 115 is able to gain access to each of the cassettes C, retrieve an unprocessed substrate W out of each cassette C, and store a processed substrate W in each cassette C. The cassettes C may be one or several types including: an SMIF (standard mechanical interface) pod; an OC (open cassette), which exposes stored substrates W to the atmosphere; or a FOUP (front opening unified pod), which stores substrates W in an enclosed or sealed space.

The BARC block 2 is positioned adjacent to the factory interface block 1. Partition 20 may be used to provide an atmospheric seal between the factory interface block 1 and the BARC block 2. The partition 20 is provided with a pair of vertically arranged substrate rest parts 30 and 31 each used as a transfer position when transferring a substrate W between the factory interface block 1 and the BARC block 2.

Referring to FIG. 1 again, BARC block 2 includes a bottom coating processor 124 configured to coat the surface of a substrate W with the AR film, a pair of thermal processing towers 122 for performing one or more thermal processes that accompany the formation of the AR film, and the transport robot 101, which is used in transferring and receiving a substrate W to and from the bottom coating processor 124 and the pair of thermal processing towers 122. Each of the coating processing units includes a spin chuck 126 on which the substrate W is rotated in a substantially horizontal plane while the substrate W is held in a substantially horizontal position through suction. Each coating processing unit also includes a coating nozzle 128 used to apply a coating solution for the AR film onto the substrate W held on the spin chuck 126, a spin motor (not shown) configured to rotatably drive the spin chuck 126, a cup (not shown) surrounding the substrate W held on the spin chuck 22, and the like.

The resist coating block 3 is a processing block for forming a resist film on the substrate W after formation of the AR film in the BARC block 2. In a particular embodiment, a chemically amplified resist is used as the photoresist. The resist coating block 3 includes a resist coating processor 134 used to form the resist film on top of the AR film, a pair of thermal processing towers 132 for performing one or more thermal processes accompanying the resist coating process, and the transport robot 102, which is used to transfer and receive a substrate W to and from the resist coating processor 134 and the pair of thermal processing towers 132. Each of the coating processing units includes a spin chuck 136, a coating nozzle 138 for applying a resist coating to the substrate W, a spin motor (not shown), a cup (not shown), and the like.

The thermal processing towers 132 include a number of vertically stacked bake chambers and cool plates. In a particular embodiment, the thermal processing tower closest to the factory interface block 1 includes bake chambers and the thermal processing tower farthest from the factory interface block 1 includes cool plates. In the embodiment illustrated in FIG. 1, the bake chambers include a vertically stacked bake plate and temporary substrate holder as well as a local transport mechanism 134 configured to move vertically and horizontally to transport a substrate W between the bake plate and the temporary substrate holder and may include an actively chilled transport arm. The transport robot 102 is identical in construction to the transport robot 101 in some embodiments. The transport robot 102 is able to independently access substrate rest parts 32 and 33, the thermal processing towers 132, the coating processing units provided in the resist coating processor 134, and the substrate rest parts 34 and 35.

The development processing block 4 is positioned between the resist coating block 3 and the scanner interface block 5. A partition 22 for sealing the development processing block from the atmosphere of the resist coating block 3 is provided. The development processing block 4 includes a development processor 144 for applying a developing solution to a substrate W after exposure in the scanner EXP, a pair of thermal processing towers 141 and 142, and transport robot 103. Each of the development processing units includes a spin chuck 146, a nozzle 148 for applying developer to a substrate W, a spin motor (not shown), a cup (not shown), and the like.

The interface block 5 is used to transfer a coated substrate W to the scanner EXP and to transfer an exposed substrate to the development processing block 5. The interface block 5 in this illustrated embodiment includes a transport mechanism 154 for transferring and receiving a substrate W to and from the exposure unit EXP, a pair of edge exposure units EEW for exposing the periphery of a coated substrate, and transport robot 104. Substrate rest parts 39 and 39 are provided along with the pair of edge exposure units EEW for transferring substrates to and from the scanner and the development processing unit 4.

The transport mechanism 154 includes a movable base 154A and a holding arm 154B mounted on the movable base 154A. The holding arm 154B is capable of moving vertically, pivoting, and moving back and forth in the direction of the pivot radius relative to the movable base 154A. The send buffer SBF is provided to temporarily store a substrate W prior to the exposure process if the exposure unit EXP is unable to accept the substrate W, and includes a cabinet capable of storing a plurality of substrates W in tiers.

Controller 160 is used to control all of the components and processes performed in the cluster tool. The controller 160 is generally adapted to communicate with the scanner 5, monitor and control aspects of the processes performed in the cluster tool, and is adapted to control all aspects of the complete substrate processing sequence. The controller 160, which is typically a microprocessor-based controller, is configured to receive inputs from a user and/or various sensors in one of the processing chambers and appropriately control the processing chamber components in accordance with the various inputs and software instructions retained in the controller's memory. The controller 160 generally contains memory and a CPU (not shown) which are utilized by the controller to retain various programs, process the programs, and execute the programs when necessary. The memory (not shown) is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits (not shown) are also connected to the CPU for supporting the processor in a conventional manner. The support circuits may include cache, power supplies, clock circuits, input/output circuitry, subsystems, and the like all well known in the art. A program (or computer instructions) readable by the controller 160 determines which tasks are performable in the processing chambers. Preferably, the program is software readable by the controller 160 and includes instructions to monitor and control the process based on defined rules and input data.

Additional description of a substrate processing apparatus in accordance with embodiments of the present invention is provided in U.S. Patent Application Publication No. 2006/0245855, entitled “Substrate Processing Apparatus,” the disclosure of which is hereby incorporated by reference in its entirety. Although embodiments of the present invention are described herein in the context of the track lithography tool illustrated in FIG. 1, other architectures for track lithography tools are included within the scope of embodiments of the present invention. For example, track lithography tools utilizing Cartesian architectures are suitable for use with embodiments as described throughout the present specification. In a particular embodiment, implementation is performed for an RF³i, available from Sokudo Co., Ltd., of Kyoto, Japan.

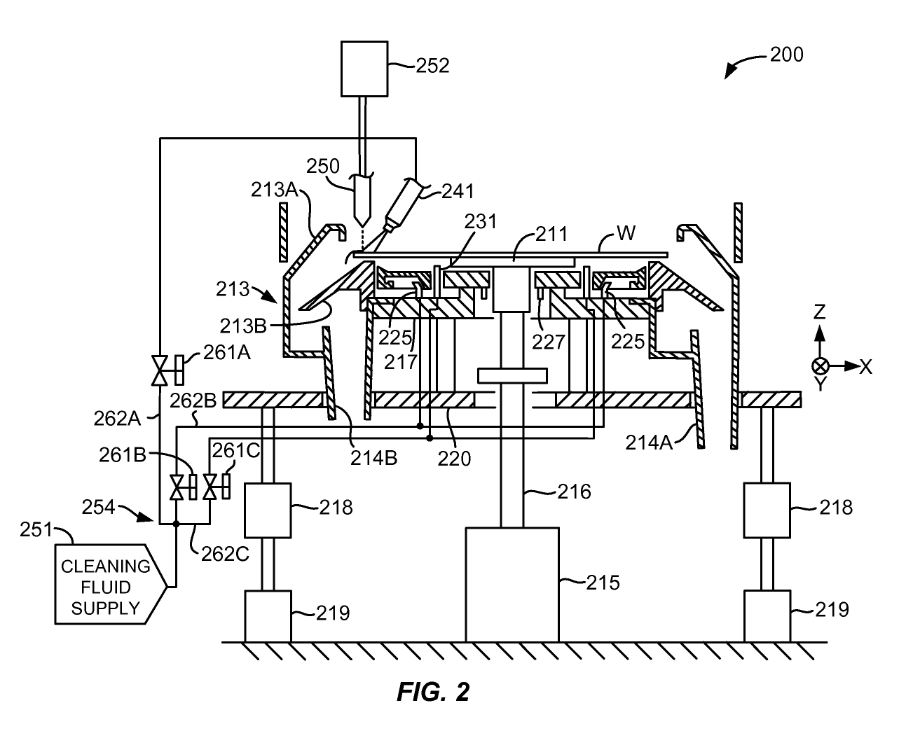

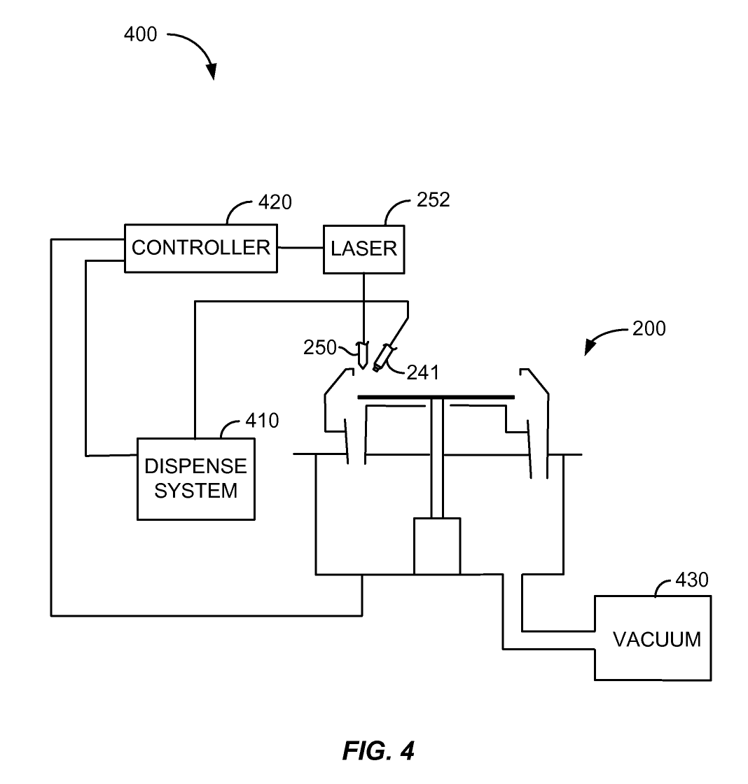

FIG. 2 is a simplified schematic diagram illustrating an edge trimming unit according to an embodiment of the present invention. The edge trimming unit 200, also referred to as an edge exposure for wafers (EEW) unit, is configured to remove peripheral portions of films formed on a substrate W. As shown in FIG. 4, the EEW 200 includes a spin chuck 211 supporting and rotating a substrate W, for example, a circular semiconductor wafer. The EEW 200 also includes a cup 213 configured to collect fluids scattered from the substrate W, an edge cleaning nozzle 241, a back surface cleaning nozzles 231 used to supply the cleaning fluid to the backside of the substrate, and a cup cleaning member 225 used to supply the cleaning fluid to the cup 213.

The edge cleaning nozzle 241 is used to supply a cleaning fluid (e.g., developer) to the peripheral edge of the substrate W. The cleaning fluid makes contact with the substrate at a first radial position measured from the center of the wafer. As illustrated, the contact between the cleaning fluid and the wafer begins at a first radial distance and continues to the edge of the wafer. Since the substrate is rotated during cleaning and edge trimming operations and the fluid is directed at an angle with respect to the surface, the fluid impinging on the surface flows away from the center of the substrate and over the edge of the substrate.

The EEW 200 also includes a light guide (i.e., an optical waveguide) optically coupled to a laser source 252. The light guide 250, which may be a fiber optic cable, is configured to direct radiation to the peripheral portion of the substrate. As illustrated in FIG. 2, the laser light impinges on the substrate at normal incidence at a position that is radially outside the location where the cleaning fluid impinges on the surface of the substrate. Thus, the laser light impinges on the surface at a radial position that is at a radial distance from the center of the substrate greater than the radial position where the cleaning fluid impinges on the substrate. Embodiments of the present invention utilize the combination of chemical treatment using the cleaning fluid and exposure to the laser radiation, which can enhance chemical reactions between the layers formed on the substrate and the cleaning fluid.

The pure spectral bandwidth provided by a laser source is used in embodiments to improve the sharpness of the exposure pattern in comparison with conventional techniques using mercury (Hg—Xe) arc lamps. The spot size of the focused beam can be decreased, providing a sharper image in the exposure plane and the wavelength can be tuned to the interact strongly with the particular cleaning fluids utilized to remove the materials on the substrate surface. Moreover, the energy of the laser beam can be selected depending on the absorption coefficients of the various layers, the cleaning fluids, and the like. One of ordinary skill in the art would recognize many variations, modifications, and alternatives.

The spin chuck 211 is generally a vacuum chuck connected to drive motor 215 through rotary shaft 216. The cup 213 is arranged to enclose the substrate W held by the spin chuck 211 and catch fluids spun off the surface of the wafer W. As illustrated in FIG. 2, the cup 213 is a double walled structure with an outer cup 213A having a rectifying member 213B arranged on the bottom of the outer cup 213A. The rectifying member 213B faces the back surface of the substrate W and is held in place by a base plate 217. The base plate 217 itself is mounted on a vertically movable plate 220 supported by a vertical pair of cylinders 218 and 219. Thus, the cup 213 is vertically movable in three stages through telescopic combination of the cylinders 218 and 219. Waste recovery drain 214A and exhaust port 214B, which is coupled to an exhaust duct (not shown) are also illustrated in FIG. 2.

The edge cleaning nozzle 241 is provided above the peripheral edge of the substrate W and is configured to supply a cleaning fluid to the peripheral portion of the substrate. In an embodiment, the cleaning fluid is a developer solution, but other fluids, either liquid or gas, are included within the scope of the present invention. The edge cleaning nozzle 241 is in fluid communication with a cleaning fluid supply 251 through an edge-side pipe 262A, a valve 261A, and manifold 254. As described more fully below, during edge cleaning processes, the substrate W is rotated on chuck 211 while valve 261A is opened to allow cleaning fluid to be provided to the peripheral portion of the substrate. The back surface cleaning nozzles 231 and the cup cleaning member 221 are also in fluid communication with the cleaning fluid supply 251 and are provided with independent valves 262B and 262C, as well as fluid supply lines 261B and 261C, respectively.

In addition to developer solution, other cleaning fluids may be utilized in various embodiments of the present invention. For example, an inorganic aqueous alkaline solution such as potassium hydroxide (KOH), sodium hydroxide (NaOH), sodium carbonate (Na₂CO₃), or the like. Additionally, although a semiconductor substrate is illustrated in FIG. 2, rectangular substrates such as substrates for liquid crystal displays may alternatively be processed in alternative embodiments.

Embodiments of the present invention provide for removal of films from the peripheral edge and the backside of the substrate W without influencing the photoresist or other films formed on the central portion of the front surface of the substrate. As described more fully below, treatment of a substrate utilizing the methods and systems described herein can remove multiple coatings, for example, BARC, photoresist, and top coat, during a single treatment process. The edge profile of the resulting layer stack can be tailored depending on the particular application to provide a vertical stack sidewall, a tapered sidewall, or a combination thereof.

Referring to FIG. 2, the light guide 250 is oriented to direct incident radiation to the substrate surface at normal incidence. In the illustrated configuration, light interacts with the cleaning fluid from edge cleaning nozzle 241 to remove one or more materials deposited on the surface of the substrate in a manner characterized by a vertical stack sidewall. In alternative embodiments, the light guide 250 is initially operated at a first radial distance from the center of the substrate, moved to a second radial distance, and then operated at the second radial distance. In another alternative embodiment, the light guide is translated during operation, producing, for example, a tapered sidewall.

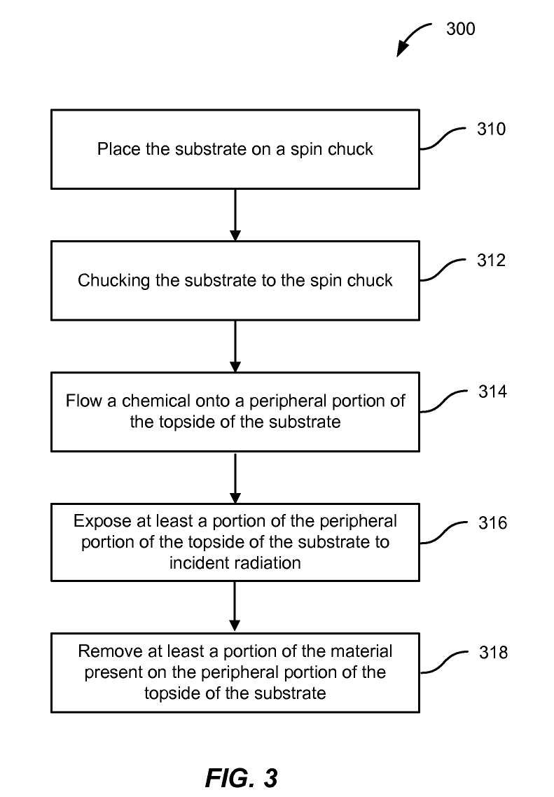

FIG. 3 is a simplified flowchart illustrating a method of performing edge trimming according to an embodiment of the present invention. In a particular embodiment, a method of processing material present on a peripheral portion of a topside of a substrate is provided. Generally, the materials include one or more layers formed on the surface of the substrate, such as BARC, resist, and/or top coat.

The method (300) includes placing the substrate on a spin chuck (310) and chucking the substrate to the spin chuck (312). Generally, the spin chuck is a vacuum chuck, but other chucks may be utilized, for example, electrostatic chucks. The substrate may be a semiconductor wafer, a panel for a flat panel application, or other suitable substrate. The substrate is rotated about an axis of the spin chuck. A chemical is flowed onto the peripheral portion of the topside of the substrate (314). Due to the trajectory of the fluid as it is dispensed from the nozzle and the rotation of the substrate, the chemical flows along a radial direction across the topside of the substrate and over the edge of the substrate.

The method also includes exposing at least a portion of the peripheral portion of the topside of the substrate to incident radiation (316). As described in relation to FIG. 2, the laser radiation, typically from a UV laser, is directed to the surface of the substrate using an optical waveguide. Generally, the laser radiation impinges on a portion of the peripheral surface of the substrate at a radial position greater than the radial position at which the fluid contacts the substrate surface. As an example, the laser producing UV radiation may be an ultraviolet diode pumped solid state (UV DPSS) laser, a UV semiconductor laser, or the like. In alternative embodiments, a laser is mounted in optical communication with the topside or upper surface of the substrate and optics are provided to direct the laser beam at the surface of the substrate. Merely by way of example, a UV semiconductor laser with integrated or external optics could be used to generate the laser beam directed toward the surface of the substrate.

The incident radiation enhances a chemical reaction between the chemical and the material, for example, photoresist and other layers deposited on the substrate or wafer. The chemical reaction, enhanced by the laser light, removes at least a portion of the material present on the peripheral portion of the topside of the substrate (318). In a specific embodiment, the edge trimming process is completed by terminating the flow of the chemical and terminating the exposure of the peripheral portion of the topside of the substrate by the incident radiation.

Generally, the laser radiation is directed at the substrate at normal incidence, although other angles of incidence are included within the scope of the present invention. As a result, in a particular embodiment, the material removed is a multi-stack layer, with a first edge of a first layer and a second edge of a second layer formed by the trimming process. The first edge and the second edge are aligned within 1 mm in one exemplary embodiment. In another exemplary embodiment the first edge and the second edge are aligned within 0.5 mm. Of course, the particular geometry of the layers trimmed using embodiments of the present invention will depend on the particular application.

It should be appreciated that the specific steps illustrated in FIG. 3 provide a particular method of performing edge trimming for a substrate according to an embodiment of the present invention. Other sequences of steps may also be performed according to alternative embodiments. For example, alternative embodiments of the present invention may perform the steps outlined above in a different order. Moreover, the individual steps illustrated in FIG. 3 may include multiple sub-steps that may be performed in various sequences as appropriate to the individual step. Furthermore, additional steps may be added or removed depending on the particular applications. One of ordinary skill in the art would recognize many variations, modifications, and alternatives.

FIG. 4 is a simplified schematic diagram illustrating a wafer edge trimming system according to an embodiment of the present invention. As illustrated in FIG. 4, the system 400 includes a treatment chamber 200 configured to receive and support the semiconductor wafer. For purposes of clarity, various elements of the treatment chamber 200 are not illustrated in FIG. 4. Additional description of the treatment chamber 200 is provided in the discussion of FIG. 2. A fluid dispense system 410 is coupled to the treatment chamber and configured to provide a chemical flow into the treatment chamber. As described above, valves and fluid lines (not illustrated) are provided to dispense chemicals, either liquid or gas, into the treatment chamber. In a specific embodiment, the fluid dispensed includes a developer solution.

Fluid dispense nozzle 241 is disposed in the treatment chamber 200 and is in fluid communication with the fluid dispense system 410. As illustrated in FIG. 4, the fluid dispense nozzle is positioned proximate to a peripheral portion of the semiconductor wafer. Generally, the fluid dispense nozzle is inclined at an angle with respect to the substrate so that fluid flowing from the dispense nozzle travels along a radius of the substrate and over the edge of the substrate. The treatment chamber includes a spin chuck on which the substrate is mounted during edge trimming operations.

The chemical from the fluid dispense nozzle, which may be a developer solution, other liquids, a gas, combinations thereof, and the like comes into contact with the layers formed on the topside of the substrate over an annular region at the periphery of the wafer. Thus, the contact between the substrate and the chemical can be referred to as occurring at a first radial distance. Generally, the first radial distance is associated with the inner portion of the annulus. The radially outward flow of the treatment fluid maintains cleanliness in the treatment chamber by washing out byproducts along with the flow of the chemicals over the edge of the substrate or wafer.

The edge trimming system 400 also includes a laser system 252 in optical communication with the treatment chamber, a controller coupled to the treatment chamber, the fluid dispense system, and the laser system, and a vacuum system 430 coupled to the treatment chamber. The laser 252 may be located external to the treatment chamber 200 or may be located internal to the treatment chamber 200. As an example, the laser may be a UV DPSS laser, a UV semiconductor laser, or the like. Generally, one or more optical elements are utilized to direct the laser radiation along an optical path between the laser and the semiconductor wafer surface. The one or more optical elements, which may be integrated into the semiconductor laser, direct the laser radiation to impinge on the peripheral portion of the semiconductor wafer at a second radial distance greater than the first radial distance. Thus, the laser radiation can interact with the chemical flowing across the surface of the semiconductor wafer, thereby enhancing chemical reactions between materials or layers present on the surface of the substrate and the chemical.

Merely by way of example, the reaction rate between the chemical and a photoresist layer deposited on the wafer surface may be very small to negligible in the absence of the laser radiation. However, the combination of the chemical and the laser radiation can produce a markedly increased reaction rate. Accordingly, edge trimming of layers present on the topside of the semiconductor wafer can be performed. Additionally, proper selection of the dispensed chemical can provide for etch selectivity between various layers, enabling trimming of an upper layer while preserving underlying layers intact. Thus, stepped profiles can be obtained, depending on the particular application. Motion of the light guide 250 can be utilized in creating stepped profiles. One of ordinary skill in the art would recognize many variations, modifications, and alternatives.

Depending on the orientation of the laser beam, the edge trimming may produce a vertical sidewall for the various layers, a tapered sidewall, or the like. Thus, embodiments of the present invention provide for sharp exposure patterns for the edge profile, which is useful in increasing wafer yields. The energy of the laser system is selected so that sufficient energy is provided to trim coated films, such as BARC and photoresist, so that either single or multiple layers of deposition can be trimmed precisely. Additionally, the laser may be scanned during processing, thereby providing an annular treatment region as the substrate rotates on the spin chuck.

Although a single laser and treatment chamber are provided in the embodiment of the present invention illustrated in FIG. 4, this pairing is not required by embodiments of the present invention. In other embodiments, a laser system may serve multiple treatment chambers. An example of a multiple chamber system applicable to embodiments of the present invention is described more fully in commonly assigned and copending U.S. patent application Ser. No. 11/111,353, which is herein incorporated by reference in its entirety. Thus, the utilization of a single laser system may be increased through the pairing of multiple treatment chambers to the single laser system. One of ordinary skill in the art would recognize many variations, modifications, and alternatives.

While the present invention has been described with respect to particular embodiments and specific examples thereof, it should be understood that other embodiments may fall within the spirit and scope of the invention. The scope of the invention should, therefore, be determined with reference to the appended claims along with their full scope of equivalents.

What is claimed is:

1. An apparatus for processing a peripheral portion of a substrate, the apparatus comprising:
a housing;
a spin chuck mounted within the housing and configured to support the substrate in a substantially horizontal orientation;
a fluid dispense nozzle coupled to the housing and proximate to the peripheral portion of the substrate, the fluid dispense nozzle being in fluid communication with a source of a chemical and configured to direct a flow of the chemical to the peripheral portion of the substrate located at a first radial distance from a center of the substrate;
a light guide optically coupled to a laser source, wherein the light guide is configured to direct radiation to the peripheral portion of the substrate located at a second radial distance from the center of the substrate greater than the first radial distance.

2. The apparatus of claim 1 wherein the substrate comprises a semiconductor wafer.

3. The apparatus of claim 1 wherein the fluid dispense nozzle is inclined at an angle with respect to the substrate having a component along a radius of the substrate.

4. The apparatus of claim 1 wherein the chemical comprises at least a developer solution.

5. The apparatus of claim 1 wherein the first radial distance is within 5 mm or less than a radius of the substrate.

6. The apparatus of claim 5 wherein the second radial distance is within 2 mm or less than the radius of the substrate.

7. The apparatus of claim 1 wherein the laser source comprises an ultraviolet diode pumped solid state laser.

8. A method of processing material present on a peripheral portion of a topside of a substrate, the method comprising:
placing the substrate on a spin chuck;
chucking the substrate to the spin chuck;
rotating the substrate about an axis of the spin chuck;
flowing a chemical onto the peripheral portion of the topside of the substrate, wherein the chemical flows along a radial direction across the topside of the substrate;
exposing at least a portion of the peripheral portion of the topside of the substrate to incident radiation, wherein the incident radiation enhances a chemical reaction between the chemical and the material; and
removing at least a portion of the material present on the peripheral portion of the topside of the substrate.

9. The method of claim 8 wherein removing at least a portion of the material comprises forming a material edge characterized by a first edge of a first layer and a second edge of a second layer, the first edge and the second edge aligned within 1 mm.

10. The method of claim 9 wherein the first edge and the second edge are aligned within 0.5 mm.

11. The method of claim 8 wherein the substrate comprises a semiconductor wafer.

12. The method of claim 8 further comprising:
terminating flowing the chemical; and
terminating exposing the peripheral portion of the topside of the substrate.

13. The method of claim 8 the material present on the peripheral portion of the topside of the substrate comprises one or more layers including at least BARC, resist, or top coat.

14. The method of claim 8 the incident radiation comprises ultraviolet radiation.

15. The method of claim 8 wherein chucking the substrate to the spin chuck comprises applying a vacuum pressure to the substrate.

16. A system for trimming an edge of a semiconductor wafer, the system comprising:
a treatment chamber configured to receive and support the semiconductor wafer;
a fluid dispense system coupled to the treatment chamber and configured to provide a chemical flow into the treatment chamber;
a fluid dispense nozzle in fluid communication with the fluid dispense system and disposed in the treatment chamber, wherein the fluid dispense nozzle is positioned proximate to a peripheral portion of the semiconductor wafer and configured to direct a flow of a chemical from the fluid dispense system to the peripheral portion of the semiconductor wafer at a first radial distance;
a laser system in optical communication with the treatment chamber;
one or more optical elements configured to direct radiation from the laser system to impinge on the peripheral portion of the semiconductor wafer at a second radial distance greater than the first radial distance; and
a controller coupled to the treatment chamber, the fluid dispense system, and the laser system.

17. The system of claim 16 wherein the chemical comprising a developer solution.

18. The system of claim 16 wherein the laser system comprises a ultraviolet laser source.

19. The system of claim 16 wherein the fluid dispense nozzle is inclined at an angle with respect to the substrate having a component along a radius of the substrate.

20. The system of claim 16 further comprising a vacuum system coupled to the treatment chamber.
